(19) United States
(12) Patent Application Publication
(10) Pub. No.: US 2011/0095152 A1
(43) Pub. Date: Apr. 28, 2011

(54) AUXILIARY EQUIPMENT FOR A FURNISHING ELEMENT, AND FURNISHING ELEMENT PROVIDED WITH SAID AUXILIARY EQUIPMENT

(75) Inventor: Marco Rusin, BAGNARIA ARSA (UD) (IT)

(73) Assignee: METAL COSTRUZIONI DI RUSIN SRL, SAN PIER D'ISONZO (GO) (IT)

(21) Appl. No.: 12/912,052

(22) Filed: Oct. 26, 2010

(30) Foreign Application Priority Data
Oct. 28, 2009 (IT) UD2009A000193

(51) Int. Cl. F16M 13/02

(52) U.S. Cl. 248/222.13

(57) ABSTRACT

Auxiliary equipment (10) for a panel or a frame of a furnishing element, able to define a support for an object. The equipment (10) comprises an attachment element (12) conformed to be attached to a surface of the panel (11) or frame, and a fastening element (13) mounted movable on the attachment element (12) so as to be selectively moved between a first closed position in which it is comprised within the lateral bulk of the attachment element (12) and a second open position, in which it protrudes laterally from the attachment element (12) and defines a fastening segment on which the object can be hung.

### FIELD OF THE INVENTION

The present invention concerns an auxiliary equipment able to be mounted on a furnishing element, such as for example a chair, a table, an article of furniture or other. In particular, the present invention concerns an auxiliary equipment that allows to support an object by keeping it suspended from the furnishing element.

The present invention also concerns the furnishing element provided with said auxiliary equipment.

### BACKGROUND OF THE INVENTION

Furnishing elements are known, such as for example chairs, tables, articles of furniture, shelves and others, each having its own specific function and a relative aesthetic conformation.

It is also known that such furnishing elements generally consist of a frame and a plurality of panels, for example seat parts, shelves, walls, wings or others, assembled together and supported by the frame so as to define the functional spaces and the overall aesthetic conformation of the furnishing element.

The design and functional conformation of known furnishing elements is very rigid and specific for their use, and may possibly be only partly configured, in any case in the context of their primary use, such as for example in extendable tables or sofa-beds or suchlike.

It is known that a user needs to take off or temporarily get rid of objects, such as for example jackets, bags, pouches or other, when he has to use a furnishing element, in particular but not only chairs, tables or other.

To avoid having to put such objects on the ground, it is known to use for support some elements that complete the furnishing element, for example the end part of a piece of furniture, the backrest of a chair, the supporting top of a table or others, thus possibly losing part of the functionality of the completion element and in any case without guaranteeing an efficient and safe support for the objects.

Moreover, sometimes, the design and sizes of the furnishing element, or at least of its completion elements, have conformations that in no way allow the support functions for objects and can easily be reached, undisturbed, by the ill-intentioned.

Auxiliary equipment is known, which can be selectively attached to the external surfaces of the panels of the frames of the furnishing elements, to function as clothes-hangers, or in any case as supports, to support the objects.

Such auxiliary equipment remains protruding from the external surfaces and, when not in use, is dangerous for a user and, in some cases, modifies in an unwanted manner the profiles and aesthetic conformations of the furnishing elements.

Purpose of the present invention is to achieve an auxiliary equipment for a furnishing element that allows to support efficiently an object with respect to the furnishing element without compromising the functionality of its components, and without being dangerous for the user or modifying the aesthetics of the furnishing element when not in use.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, an auxiliary equipment according to the present invention is applied preferentially, but not exclusively, to a panel or frame of a furnishing element, to define a support for an object. The frame can consist of any material, for example plastic, wood, metal or other.

According to a characteristic feature of the present invention, the auxiliary equipment comprises an attachment element conformed to be attached to a surface of the panel or frame of the furnishing element, and a fastening element mounted movable on the attachment element and able to be selectively moved between a first closed position, in which it is comprised in the lateral bulk of the attachment element, and a second open position, in which it protrudes laterally from the attachment element and defines a fastening segment, for example a hook, on which the object can be hung.

With the present invention, therefore, the fastening element, in a condition of non-use, remains comprised within the lateral bulk of the attachment element, so as to reduce to a minimum both the risk of being accidentally knocked by a user, and also any variation in the aesthetic impact with respect to the design of the furnishing element to which it is applied.

Advantageously, the attachment element is mounted on the panel or frame of the furnishing element on a substantially hidden surface, such as for example the lower surface of a seat, a table top, a bracket or other.

In this way, the equipment is further hidden from view, both in the open condition and also, more so, in the closed condition.

According to a variant, the assembly of the fastening element on the attachment element is guided by elastic means, which tend to keep the fastening element close up to the attachment element, both in the first closed position and also in the second open position.

In this way, the fastening element is always in a very close-up condition with respect to the attachment element, so as to further limit the risk of accidental knocks and variation in the aesthetic impact of the furnishing element.

According to a variant, the attachment element comprises a cam member disposed in correspondence with the assembly zone with the fastening element In the same variant solution, the fastening element comprises a cam follower member, or pin, able to cooperate by sliding on the cam member, during the rotation of the fastening element between the first and second position.

In this way, the opening and closing movement of the fastening element with respect to the attachment element is effectively constrained by the desired conformation of the cam member, and is always optimum.

According to another variant, the fastening element is substantially U-shaped.

According to another variant, the attachment element comprises at least an attachment plate able to be mounted, for example using screws, on the relative surface of the panel or frame of the furnishing element.

According to another variant, the attachment plate comprises an assembly bushing, extending from the surface opposite the visible surface of the plate, and able to define an axial sliding guide of the fastening element with respect to the attachment element.

According to another variant, the plate of the attachment element provides a housing seating conformed to keep the attachment element at least in its first closed position.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral view of an auxiliary equipment according to the present invention, applied to a shelf of a furnishing element, in a first operating condition;

FIG. 2 shows a lateral view from II of the equipment in FIG. 1, in a second operating condition;

FIG. 3 shows a plane view of the equipment in FIG. 1;

FIG. 4 is a three-dimensional view from above of the equipment in FIG. 1;

FIG. 5 is a three-dimensional view from below of the equipment in FIG. 1.

To facilitate comprehension, the same reference numbers have been used, where possible, to identify common elements that are substantially identical in the drawings. It is understood that elements and characteristics of one form of embodiment can conveniently be incorporated in other forms of embodiment without any further clarifications.

### DETAILED DESCRIPTION OF A PREFERENTIAL FORM OF EMBODIMENT

With reference to the attached drawings, an auxiliary equipment 10 is shown in its entirety, for supporting objects, mounted on a panel 11 of a furnishing element, for example a table, of a substantially known type and not shown in the drawings.

The auxiliary equipment 10 according to the present invention comprises an attachment plate 12 and a fastening element 13 mounted movable on the attachment plate 12.

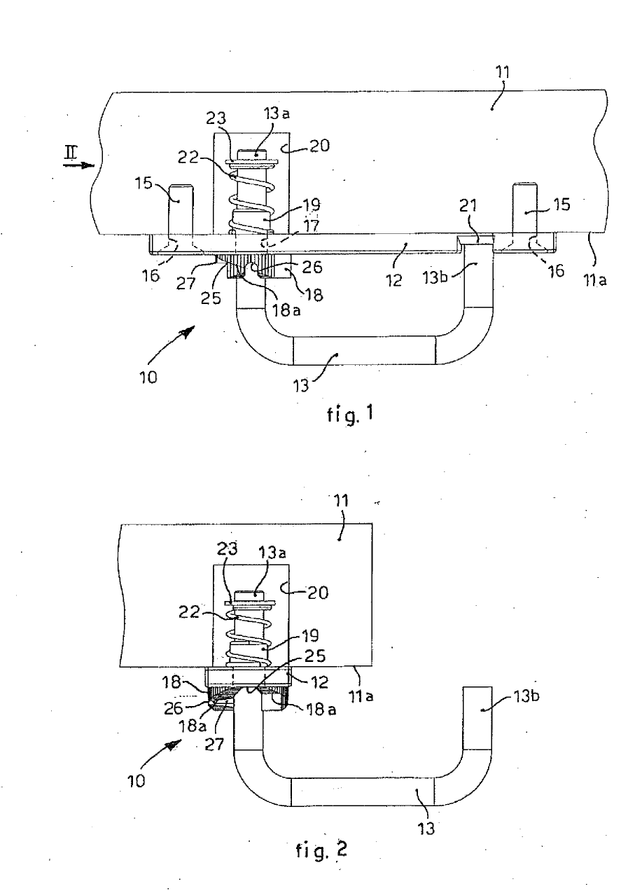

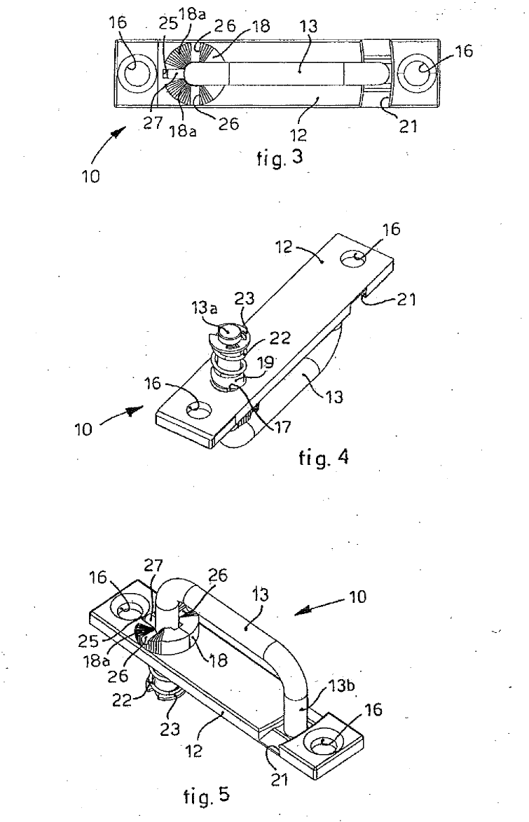

In particular, the fastening element 13 is selectively movable between a first closed position in which it is comprised in the lateral bulk of the attachment plate 12 (FIG. 1), and a second open position in which it protrudes laterally from the bulk of the attachment plate 12 (FIG. 2).

The attachment plate 12 is advantageously made by molding, is substantially shaped like a flattened parallelepiped and is able to be attached, for example by means of screws 15 for wood, self-threading or others, to a surface 11a of the panel 11, in this case the surface 11a facing toward the bottom of the panel 11.

It is not to be excluded that the plate 12 can be shaped so as to be effectively mounted also on vertical, oblique surface or other kinds of surface, for example shaped, flat, cylindrical or oval.

The attachment plate 12 comprises two attachment holes 16 made through in proximity with the lateral ends of the attachment plate 12; the attachment holes 16 allow the through insertion of the screws 15, in order to attach the attachment plate 12 to the surface 11a of the panel 11.

A positioning seating 21 is also made on the attachment plate 12 for the fastening element 13 in the first closed position. The positioning seating 21 is open laterally and is conformed so as to follow the rotation of the fastening element 13 between the first closed position and the second open position.

An assembly hole 17 is also made on the attachment plate 12, also made through, and able to allow the insertion with play of one end of the fastening element 13.

In this case, the attachment plate 12 also comprises an assembly bushing 19, which extends perpendicularly, or in some applications obliquely, to the attachment plate 12, in a position substantially coaxial to the assembly hole 17 and on the opposite side with respect to the visible surface of the attachment plate 12.

The assembly bushing 19, when the attachment plate 12 is mounted on the panel 11, is housed in a corresponding housing seating 20 made in the panel 11.

The attachment plate 12 also comprises a cam 18 disposed in correspondence with the assembly hole 17 on the opposite side with respect to the assembly bushing 19, the function of which will be explained hereafter.

In particular, the cam 18 defines two sliding walls 18a inclined with respect to the plane on which the attachment plate 12 lies. The sliding walls 18a are identical and opposite each other.

The cam 18 also comprises a first positioning seating 25 and two second positioning seatings 26; the latter are made on the cam 18 offset by about 90° with respect to the first positioning seating 25 and disposed at about 180° degrees with respect to each other.

Each sliding wall 18a begins from the first positioning seating 25 and ends in correspondence with a respective second positioning seating 26.

The fastening element 13 is substantially U-shaped and is made with a bent metal round piece, so as to define a first assembly end 13a, and a second fastening end 13b.

The metal round piece can be made of light alloy, resin or other material with suitable mechanical characteristics.

The first end 13a and the second end 13 are at relatively different heights with respect to each other, so that the two ends 13a and 13b can cooperate differently with the attachment plate 12.

In particular, the first end 13a is inserted through, both through the assembly hole 17 and also through the assembly bushing 19, to define the movable assembly of the fastening element 13 with respect to the attachment plate 12. This assembly condition allows the passage from the first closed position to the second open condition, substantially by means of a rotation of the fastening element 13 with respect to the attachment plate 12.

In proximity with the first end 13a a cam follower pin 27 is radially attached, which is housed inside the first positioning seating 25 when the fastening element 13 is in the first closed position, and in one or the other of the second positioning seatings 26, when the fastening element 13 is in its open position.

In this way, the rotation of the fastening element 13 with respect to the attachment plate 12 determines the passage of the pin 27 from the first positioning seating 25 to the corresponding second positioning seating 26, depending on whether the rotation of the fastening element 13 takes place clockwise or anti-clockwise. This passage determines the sliding of the pin 27 on one of the two sliding walls 18a, so as to determine an axial component to the movement of the fastening element 13 with respect to the attachment plate 12.

The second end 13b, in the first closed position, is disposed in contact with the visible surface of the attachment plate 12, advantageously inserted at least partly in the positioning seating 21, whereas in the second open position it is free and allows to position an object on the fastening element 13.

The auxiliary equipment 10 according to the present invention also comprises a helical spring 22 disposed inside the housing seating 20, in a coaxial position with the assembly bushing and with the first end 13a of the fastening element 13.

In particular, the helical spring 22 cooperates elastically, with a first end, with a washer 23, which is keyed coaxially to the end 13a of the fastening element 13 and, with a second end, to the non-visible surface of the attachment plate 12.

In this way, the helical spring 22 can be selectively compressed with every reciprocal axial movement of the fastening element 13 and the attachment plate 12, elasticizing the relative movement.

Advantageously, the conformation of the cam 18 and the relative reciprocal position of the first positioning seating 25 and the second positioning seatings 26 is such that when the pin 27 is disposed in the second positioning seating 26 the helical spring 22 is more compressed. The compression increases the retaining force of the pin 27 inside the second positioning seating 26, so as to make the positioning of the fastening element 13 more stable in its second open position.

The auxiliary equipment 10 as described heretofore functions as follows.

The attachment plate 12 is attached by means of the screws 15 to the surface 11a of the panel 11, advantageously in proximity with an external lateral edge of the panel 11.

Before the attachment plate 12 is attached to the panel 11, the housing seating 20 is made for the assembly bushing 19.

The fastening element 13 is normally in its first closed position, and therefore is completely hidden from sight and comprised within the bulk of the attachment plate 12.

When it becomes necessary to use the fastening element 13 in order to fasten an object to it, for example a bag, the fastening element is drawn by making the fastening element 13 rotate around its first end 13a, until it reaches the second open position, in which at least the second end 13b is laterally extracted from the positioning seating 21, protrudes from the lateral bulk of the attachment plate 12 and possibly also from that of the panel 11, as in this case.

The drawing action must clearly be greater than the elastic force of the helical spring 22, in order to make the pin 27 emerge from the first positioning seating 25 and determine the sliding thereof along the sliding wall 18a, until the second positioning seating 26 is reached.

In this step, the second end 13b is completely free from the housing seating 20.

Once the fastening element 13 has been released, the helical spring 22 and the cooperation between the pin 27 and the second positioning seating 26 cause a stabilization of the position reached by the fastening element 13.

At the end of use, the fastening element 13 is closed by an inverse sequence with respect to the opening sequence as described above.

The auxiliary equipment 10 according to the present invention can also be used to support objects in its closed condition, in which the fastening element 13 defines a closed space with the attachment plate 12.

In this condition, the objects supported, for example a bag by means of its shoulder strap, are safer from possible attempted thefts.

It is clear that modifications and/or additions of parts may be made to the auxiliary equipment 10 as described heretofore, without departing from the field and scope of the present invention.

For example, it comes within the field of the present invention to provide an attachment plate 12 without the assembly bushing 19, or where the assembly bushing 19 defines the housing seating 20.

It is also clear that, although the present invention has been described with reference to some specific examples, a person of skill in the art shall certainly be able to achieve many other equivalent forms of auxiliary equipment for a furnishing element, and furnishing element provided with said auxiliary equipment, having the characteristics as set forth in the claims and hence all coming within the field of protection defined thereby.

1. Auxiliary equipment for a panel or a frame of a furnishing element, able to define a support for an object, wherein the equipment comprising an attachment element conformed to be attached to a surface of said panel or frame, and a fastening element mounted movable on said attachment element and able to be selectively moved between a first closed position in which it is comprised within the lateral bulk of said attachment element and a second open position, in which it protrudes laterally from said attachment element and defines a fastening segment on which the object can be hung, wherein the attachment element comprises a cam member disposed in correspondence with the assembly zone with the fastening element, wherein said cam element comprises a first positioning seating and at least one second positioning seating offset with respect to said first positioning seating, wherein said fastening element comprises a cam follower member slideable on said cam member during the rotation of the fastening element between the first closed position and the second open position, and wherein said cam follower member is stably positioned in said first positioning seating when the fastening element is in its first closed position, and is stably positioned in said second positioning seating when the fastening element is in its second open position.

2. Equipment as in claim 1, wherein said second positioning seating is offset by about 90° with respect to the first positioning seating.

3. Equipment as in claim 1, wherein said cam element comprises two second positioning seatings, disposed at about 180° degrees each other and each defining respective stable open position of the fastening element when it is respectively rotated clockwise or anti-clockwise moving from its first closed position to its second open position.

4. Equipment as in claim 1, further comprising elastic means disposed in cooperation between the fastening element and the attachment element, and able to maintain said fastening element close up to said attachment element, both in the first closed position and also in the second open position.

5. Equipment as in claim 1, wherein the fastening element is substantially “U” shaped.

6. Equipment as in claim 1, wherein the attachment element comprises at least an attachment plate able to be assembled on the relative surface of the panel or frame of the furnishing element.

7. Equipment as in claim 6, wherein the attachment plate comprises an assembly bushing, extending from the surface opposite the visible surface of said attachment plate, and is able to define an axial guide for the fastening element.

8. Equipment as in claim 1, wherein the attachment plate provides a positioning seating conformed to keep the fastening element at least in its first closed position.

9. Furnishing element provided with an auxiliary equipment having the features according to claim 1.
